(19) United States
(12) Patent Application Publication
(10) Pub. No.: US 2026/0257171 A1
(43) Pub. Date: Sep. 3, 2026

(54) APPARATUS, SYSTEMS, AND METHODS FOR ENHANCED CAPTURE OF CARBON DIOXIDE FROM AMBIENT AIR USING LIQUID SOLVENT

(71) Applicant: Capture6 Corp, Berkeley, CA (US)

(72) Inventors: Ethan Cohen-Cole, Berkley, CA (US); Rahul Surana, Fremont, CA (US); Alishan Salim, Spring, TX (US)

(73) Assignee: Capture6 Corp, Berkeley, CA (US)

(21) Appl. No.: 19/489,190

(22) PCT Filed: Jun. 3, 2024
(86) PCT No.: PCT/US2024/032288

§ 371 Date: Dec. 1, 2025

Related U.S. Application Data
(60) Provisional application No. 63/470,699, filed on Jun. 2, 2023.

(51) Int. Cl. B01D 53/62; B01D 46/00; B01D 53/00; B01D 53/14; B01D 53/26; B01D 53/75; B01D 53/76; B01D 53/78

(52) U.S. Cl. CPC B01D 53/62; B01D 46/0032; B01D 53/002; B01D 53/1406; B01D 53/1475; B01D 53/265; B01D 53/266; B01D 53/75; B01D 53/76; B01D 53/78; B01D 2257/504; B01D 2257/80; B01D 2258/06

(57) ABSTRACT

A method for capturing carbon dioxide (CO₂) from ambient air includes receiving and passing an air flow with ambient air through a packing fill in a laminar manner, introducing a liquid solvent into the packing fill, producing a first stream of aqueous carbonate solution through a reaction between the liquid solvent and CO₂ in the laminar air flow, introducing the liquid solvent into a scrubbing chamber, passing the air flow through the scrubbing chamber in a turbulent manner, mixing the turbulent air flow with the liquid solvent in the scrubbing chamber to produce a second stream of aqueous carbonate solution through a reaction between the liquid solvent and CO₂ in the turbulent air flow, and exhausting the air flow with less CO₂ than when receiving the air flow.

### CROSS-REFERENCE TO RELATED APPLICATION(S)

This application claims the benefit under 35 U.S.C. § 119(e) to U.S. Provisional Application 63/470,699, filed Jun. 2, 2023, and entitled “APPARATUS, SYSTEMS, AND METHODS FOR ENHANCED CAPTURE OF CARBON DIOXIDE FROM AMBIENT AIR USING LIQUID SOLVENT,” which is hereby incorporated herein by reference in its entirety.

### TECHNICAL FIELD

The disclosed technology relates generally to the development and modification of equipment, methodologies, and design principles for the capture of carbon dioxide from the ambient air using liquid solvents.

### BACKGROUND

Reducing the emissions of climate gases including carbon dioxide is essential to avoiding the worst scenarios for global warming. Curtailing emissions, while essential, is not sufficient by itself, because a stock of carbon dioxide (CO₂) emissions has been accumulating in the atmosphere since the dawn of the industrial revolution and countries around the world are not acting sufficiently quickly to reduce their emissions.

The natural processes that uptake this CO₂ released by fossil fuels take a long time to work. As just one example, ocean absorption of CO₂ from the atmosphere takes about a year to equilibrate. Eliminating the balance of CO₂ requires weathering and rock formation-processes that operates on geologic time scales of tens to hundreds of thousands of years.

Given the need to quickly reduce future emissions as well as the existing stock of CO₂, there is a need for approaches that pull existing climate gases (predominantly CO₂) out of the air or water. Removing CO₂ directly from ambient air is sometimes referred to as Direct Air Carbon Capture and Storage or DACCS.

Current methods for direct air capture of CO₂ typically involve blowing ambient air through a device such as a cooling tower or an air contactor. These standard devices are designed largely for heat transfer, e.g., cooling the liquid with air, and hence there is a need to modify the devices for mass transfer to absorb CO₂ from the ambient air into a liquid solvent. Modifications to date have centered around increasing the depth of packing structures within the devices to allow more gas-liquid interfacial area.

Thus, there is a continued need for improved systems, devices, and methods for capturing CO₂ from ambient air.

### BRIEF SUMMARY

The disclosed technology relates to advancements in gas-liquid contactors to enhance the mass transfer and the efficiency of carbon dioxide absorption from ambient air. In various cases, the disclosed technology relates to the capture of carbon dioxide from the atmosphere into liquid solvents to form carbonates. Various implementations improve and enhance the mass transfer of carbon dioxide from the air into the solvents by one or more of modifying the air flow rate, introducing a solvent concentration gradient, and increasing the gas-liquid interfacial area by atomizing the liquid solvent. For example, various implementations of the proposed systems, devices, and methods optimize both laminar and turbulent airflow regimes, thus facilitating higher rates for the carbonation process. In various cases, another modification includes the use of gradients in the solvent concentration to improve carbon dioxide absorption, the use of surfactants to improve wetting efficiency, and/or the use of advanced technologies to recover water from the exhaust air, thereby reducing water loss. The use of surfactants in the liquid solvent can improve wetting efficiency and reduce water loss by inducing electrical and/or thermal condensation of water in the outgoing air. Another possible modification is to atomize the liquid solvent molecules, thereby improving the gas-liquid mass transfer coefficients and enabling higher throughput from the system. These modifications, when implemented individually or in various combinations improve the capture of carbon dioxide from ambient air.

Discussed herein are various devices, apparatus, systems, and methods related to the capture of carbon dioxide from ambient air with a liquid solvent. Various implementations of the apparatus, systems, and methods employ one or more of the following elements: a device through which ambient air is blown-such as a cooling tower, the dispersion of liquid solvent, a packing structure and/or a chamber to enable gas-liquid contact. and the conversion of the liquid solvent into carbonates with the absorption of CO₂ from the ambient air.

The current innovation encompasses equipment and processes that enhance the mass transfer and fully utilize the materials and equipment for the capture of carbon dioxide from ambient air using a liquid solvent. These modifications improve and enhance the reaction between CO₂ from the ambient air with the liquid solvent to form carbonates. Innovative carbon dioxide capture devices incorporating one or more such improvements are at times referred to herein as ambient air reactors (AARs). Various implementations of the ambient air reactors incorporate such improvements and modifications to further facilitate the transfer of carbon dioxide from a gas phase to the liquid phase forming carbonates. Various implementations of the technology repurpose standard devices, such as cooling towers and air contactors, as ambient air reactors by modifying the devices to incorporate one or more of the improvements described herein.

Examples of various implementations of the disclosed technology include, but are not limited to, the following:

An apparatus or system or method for enhancing the capture of carbon dioxide (CO₂) from the atmosphere, using a liquid solvent and a direct and/or passive air capture system, thereby producing a liquid carbonate solution containing air-captured CO₂. The device/system/method enables gas-liquid contact wherein the liquid solvent is exposed to ambient air moving in either counter-current, co-current, or cross-current directions. The ambient air, moving through in a laminar flow, enables the mass transfer of carbon dioxide from the gas phase to the liquid phase.

In various optional implementations, renewable energy is used to operate the system, including all necessary pumps and fans, to thus lower the carbon intensity of the process.

In various optional implementations, the passive/direct air capture system includes a fan to induce air, in a laminar flow, through a packing fill enabling the capture of CO₂ from the ambient air into the liquid solvent.

In various optional implementations, additional air is introduced into the device, at an angle and at a higher velocity, such that the ambient air moves through in a turbulent flow enhancing the mass transfer of carbon dioxide from the gas phase to the liquid phase. In various cases, the air capture system is optionally modified to include a vortex scrubbing section with a blower to enable turbulent air flow for enhanced reaction conversion and extraction of CO₂ from the ambient air in the ambient air reactor.

In various optional implementations, the solvent is introduced into the ambient air reactor such that a concentration gradient is formed along the length of the air travel facilitating a steady absorption rate of CO₂ into the liquid solvent. For example, the liquid solvent can be optionally introduced into the device with a gradient in the solvent concentration to enable enhanced mass transfer for carbon dioxide from the gas phase to the liquid phase. In various cases the gradient is maintained in both collection and distribution basins and optionally with separate pumping systems.

In various optional implementations, the incoming air is contacted against atomized solvent droplets to reduce the temperature of the outlet air through evaporative cooling to lower the water vapor losses of the system while capturing CO₂ from the air. For example, the liquid solvent can be optionally atomized by passing it through a constrictor or a funnel, such as a venturi, and is exposed to ambient air moving in a turbulent manner to improve the mass transfer of carbon dioxide from the gas phase to the liquid phase. In various optional examples an AAR includes a venturi scrubber section that atomizes the liquid solvent as it comes in contact with ambient air to improve the extraction of CO₂ out of the ambient air.

In various optional implementations, an additional separation chamber with or without packing is optionally added (e.g., in series with a venturi scrubber) for further extraction of carbon dioxide from the air into the liquid solvent and to reduce the mist of solvent in the outgoing air.

In various optional implementations, a surfactant is added to the liquid solvent to increase the wetting efficiency of the solvent thereby increasing the gas-liquid interfacial area and the CO₂ absorption rate. For example, the wetting of the packing enabling the gas-liquid contact is optionally improved by adding surfactants in the liquid solvent thereby enhancing the mass transfer of carbon dioxide from the gas phase to the liquid phase. The surfactants can also reduce water vapor loss in the outlet air.

In various optional implementations, water loss in the outgoing air is reduced by cooling the air or by electrically charged mesh wires that attract the water molecules and prevent them from escaping with the outgoing air. For example, the air can be optionally cooled utilizing a series of cooling plates or coils which contact the outlet air and reduce its temperature to condense the water vapor present in the exiting air. As another example, an electrically charged wire or a hollow tubing mesh with or without coolant flow is optionally used to reduce the water vapor content in the exhaust air via electrical or temperature induced condensation.

Additional examples of various implementations of the disclosed technology include, but are not limited to, the following:

A method for capturing carbon dioxide (CO₂) from ambient air, comprising receiving an air flow comprising ambient air; passing the air flow through a packing fill in a laminar manner, the air flow comprising a laminar air flow within the packing fill; introducing a liquid solvent into the packing fill; producing a first stream of aqueous carbonate solution through a reaction between the liquid solvent and CO₂ in the laminar air flow; introducing the liquid solvent into a scrubbing chamber; passing the air flow through the scrubbing chamber in a turbulent manner, the air flow comprising a turbulent air flow within the scrubbing chamber; mixing the turbulent air flow with the liquid solvent in the scrubbing chamber to produce a second stream of aqueous carbonate solution through a reaction between the liquid solvent and CO₂ in the turbulent air flow; and exhausting the air flow with less CO₂ than when receiving the air flow.

In various cases the method includes one or more of the following optional aspects and features:

Adding turbulence to the air flow within the scrubbing chamber by blowing additional air into the scrubbing chamber at an acute angle relative to a direction of the air flow entering the scrubbing chamber and with a speed greater than a speed of the air flow entering the scrubbing chamber; blowing additional air into the scrubbing chamber to add turbulence to the air flow within the scrubbing chamber; blowing the additional air into the scrubbing chamber at an acute angle relative to a direction of the air flow entering the scrubbing chamber; blowing the additional air along an inside perimeter of the scrubbing chamber; blowing the additional air into the scrubbing chamber with a speed greater than a speed of the air flow entering the scrubbing chamber; wherein the additional air comprises a recycled portion of the exhausted air flow; and wherein the additional air is fresh ambient air.

The method wherein the first stream comprises carbonates, water, and an unreacted portion of the liquid solvent; wherein introducing the liquid solvent into the packing fill comprises introducing a recycled portion of the first stream; and wherein introducing the liquid solvent into the scrubbing chamber comprises introducing a recycled portion of the first stream and/or the second stream.

The method optionally includes pushing and/or pulling the air flow with an axially mounted fan.

The method optionally including atomizing the liquid solvent, passing the air flow through the atomized liquid solvent, and producing a third stream of aqueous carbonate solution through a reaction between the atomized liquid solvent and CO₂ in the air flow; passing the air flow through a venturi while introducing the liquid solvent into the venturi to atomize the liquid solvent; wherein atomizing the liquid solvent comprises spraying the liquid solvent with at least one atomizing spray nozzle; passing the air flow through a separation chamber configured to reduce entrainment of the liquid solvent in the air flow; passing the air flow through the separation chamber in a turbulent manner; wherein the separation chamber comprises additional packing fill and further comprising introducing the liquid solvent into the additional packing fill and passing the air flow through the additional packing fill.

The method wherein introducing the liquid solvent into the packing fill comprises introducing the liquid solvent with a concentration gradient along the direction of the air flow through the packing fill; wherein introducing the liquid solvent with a concentration gradient comprises introducing two or more concentrations of the liquid solvent into corresponding separate regions of the packing fill; wherein the packing fill comprises an air flow entrance and an air flow exit, the first region is closer to the air flow entrance than the second region and the second region is closer to the air flow exit than the first region, and the second concentration is greater than the first concentration.

The method optionally including passing the air flow through a water vapor filter, thereby removing water vapor from the air flow; wherein the water vapor filter comprises a mesh, and further comprising electrically charging the mesh to attract and condense water vapor molecules upon the mesh; and wherein the water vapor filter comprises tubing, and further comprising flowing a coolant through the tubing to cool the air flow and condense water vapor molecules upon the tubing.

Another example of a method includes a method for capturing carbon dioxide (CO₂) from ambient air that includes receiving an air flow comprising ambient air; passing the air flow through a packing fill comprising an air flow entrance and an air flow exit; introducing a liquid solvent into the packing fill with a concentration gradient, comprising: introducing a first concentration of the liquid solvent into a first region of the packing fill and introducing a second concentration of the liquid solvent into a second region of the packing fill, wherein the second concentration is greater than the first concentration, and wherein the first region is closer to the air flow entrance than the second region and the second region is closer to the air flow exit than the first region; producing a first stream of aqueous carbonate solution through a reaction between the first concentration of the liquid solvent and CO₂ in the air flow within the first region of the packing fill; producing a second stream of aqueous carbonate solution through a reaction between the second concentration of the liquid solvent and CO₂ in the air flow within the second region of the packing fill; and exhausting the air flow with less CO₂ than when receiving the air flow.

In various cases the method optionally includes wherein introducing the first concentration of the liquid solvent into the first region of the packing fill comprises introducing a recycled portion of the first stream; and wherein introducing the second concentration of the liquid solvent into the second region of the packing fill comprises introducing a recycled portion of the second stream.

Another example of a method includes a method for capturing carbon dioxide (CO₂) from ambient air that includes receiving a pressurized air flow comprising ambient air; passing the pressurized air flow through an atomization stage comprising a venturi; introducing a pressurized liquid solvent into the venturi thereby atomizing the liquid solvent; producing a first amount of aqueous carbonate solution through a reaction between the atomized liquid solvent and CO₂ in the air flow; passing the air flow through a separation chamber configured to reduce entrainment of the liquid solvent in the air flow; and exhausting the air flow with less CO₂ than when receiving the air flow.

In various cases the method optionally includes wherein passing the air flow through the separation chamber comprises passing the air flow in a turbulent manner and wherein passing the air flow through the separation chamber comprises passing the air flow through a packing fill; and further comprising introducing the liquid solvent into the packing fill; and producing a second amount of aqueous carbonate solution through a reaction between the liquid solvent in the packing fill and CO₂ in the air flow in the packing fill.

Another example of a method includes a method for capturing carbon dioxide (CO₂) from ambient air that includes receiving an air flow comprising ambient air; passing the air flow through one or more of a packing fill and a venturi; introducing a liquid solvent into the one or more of the packing fill and the venturi; producing an amount of aqueous carbonate solution through a reaction between the liquid solvent and CO₂ in the air flow; passing the air flow through a water vapor filter, thereby removing water vapor from the air flow; and exhausting the air flow with less CO₂ than when receiving the air flow.

The method optionally includes wherein the water vapor filter comprises a mesh, and further comprising electrically charging the mesh to attract and condense water vapor molecules upon the mesh; and/or wherein the water vapor filter comprises tubing, and further comprising flowing a coolant through the tubing to cool the air flow and condense water vapor molecules upon the tubing.

While multiple embodiments are disclosed, still other embodiments of the disclosure will become apparent to those skilled in the art from the following detailed description, which shows and describes illustrative embodiments of the disclosed apparatus, systems, and methods. As will be realized, the disclosed apparatus, systems, and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIGS. 1A and 1B are general flow diagrams of standard carbon capture devices with counter-current flow and cross-current flow configurations, respectively, wherein liquid solvent is fed from the top and carbon dioxide is absorbed from the air that is flowing through the devices.

FIG. 1A is a schematic side-view cross-section of a counter-current flow ambient air reactor according to various implementations. The AAR internals are configured for ambient air to flow in a laminar manner (bottom chamber) as well as in a turbulent manner (top chamber) while the air interfaces with the liquid solvent.

FIG. 1B is a schematic side-view cross-section of a cross-current flow ambient air reactor according to various implementations. The AAR internals are configured for ambient air to flow in a laminar manner (bottom chamber) as well as in a turbulent manner (top chamber) while the air interfaces with the liquid solvent.

FIG. 1C is a top-view depiction of the AAR of FIG. 1B showing two distribution channels for the liquid solvent, thereby introducing a concentration gradient in the cross-current flow AAR according to various implementations. In this depiction the higher solvent concentration (fresh solvent) is introduced in the inner region of the AAR which interfaces with ambient air with reduced carbon dioxide concentration and the lower solvent concentration (recycled solvent) is introduced in the outer region of the AAR which interfaces with relatively higher CO₂ concentration. The concentration gradient enables the steady absorption of CO₂ into the liquid solvent.

FIGS. 1D and 1E are schematic side and top views, respectively, of an AAR top section that has been configured as an additional air scrubber with turbulent flow according to various implementations. In the top section, additional air, either fresh or recycled, is introduced into the chamber, preferably at an angle to enable the turbulent flow.

FIG. 2A is a schematic depiction of an ambient air reactor including an atomization stage with a venturi and a gas-liquid separator according to various implementations. The venturi atomizes the liquid solvent to increase the gas-liquid interfacial area, thus aiding higher mass transfer, and the separator reduces the mist of solvent in the outgoing air.

FIG. 2B is a schematic depiction of an ambient air reactor that includes an atomization stage with a venturi and a secondary separator component with additional packing according to various implementations. The venturi is for atomizing the liquid solvent and the secondary separator component with additional packing distributes solvent to further improve the mass transfer of CO₂ from the ambient air into the liquid solvent.

FIG. 3A shows a mesh that can be introduced in the exhaust of an AAR according to various implementations. The mesh carries an electrical charge that attracts the water and solvent molecules thereby reducing water vapor loss from the equipment.

FIG. 3B depicts a top view of a mesh formed from hollow tubes according to various implementations. The mesh can be introduced in the exhaust of an AAR and can carry an opposing electrical charge and/or a coolant flow to reduce water vapor loss in the exiting air.

FIGS. 4A and 4B are schematic, cross-section diagrams of two AARs according to various implementations. The AARs have a cross-current flow configuration along with an atomization stage including a spray tower section with no packing, and a cooling plate and/or electrically charged wire mesh to reduce the outlet air temperature and thereby reduce water vapor loss in the outlet air.

### DETAILED DESCRIPTION

The various examples and implementations disclosed or contemplated herein relate to apparatus, systems, and methods that enhance and improve the capture of carbon dioxide from ambient air using liquid solvents. In various cases, improvements in the gas-liquid mass transfer are achieved by modifying the flow and the form of the liquid phase, the gas phase, or both the liquid and gas phases. Various improvements include, among others, apparatus, systems, and methods that can atomize the liquid, change the airflow from laminar to turbulent, and/or increase the concentration gradient for mass transfer.

Additional embodiments disclosed or contemplated herein relate to apparatus, systems, and methods to reduce the water loss in the outgoing air. Various implementations include, for example, reducing the temperature of the outgoing air, and/or using electrical mesh to attract water molecules, thus preventing them from escaping with outgoing air.

Implementations of the disclosed systems and methods can be combined or otherwise utilized with other examples herein. In various cases the teachings of one or more implementations disclosed herein can apply and be used with other implementations disclosed herein, as well as with examples and teachings discussed in related U.S. application Ser. No. 18/082,903, filed Dec. 16, 2022, and entitled “Systems and Methods for Direct Air Carbon Dioxide Capture, and U.S. application Ser. No. 18/480,779, filed Dec. 16, 2022, and entitled “Systems and Methods for Integrated Direct Air Carbon Dioxide Capture and Desalination Mineral Recovery,” both of which are hereby incorporated by reference in their entirety. Various implementations can make use of the technologies disclosed in the other examples and aspects, such that the teachings contained herein all relate to variations on the implementations disclosed elsewhere herein. One of skill in the art would readily appreciate that in certain implementations, features or other aspects disclosed in any specific example detailed herein can be combined with additional features outlined in alternate examples, such that the instant disclosure contemplates combining various features for individual applications of the disclosed technology. Further, those skilled in the art will appreciate that the disclosed examples omit various standard components, features, and details for clarity and brevity, including, for example, various pumps, tanks, pipes, control systems, and other aspects well-known in the art.

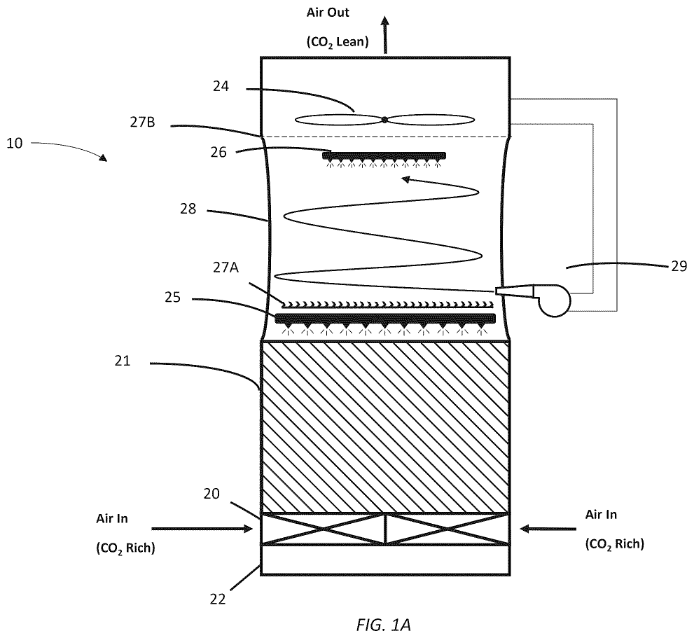

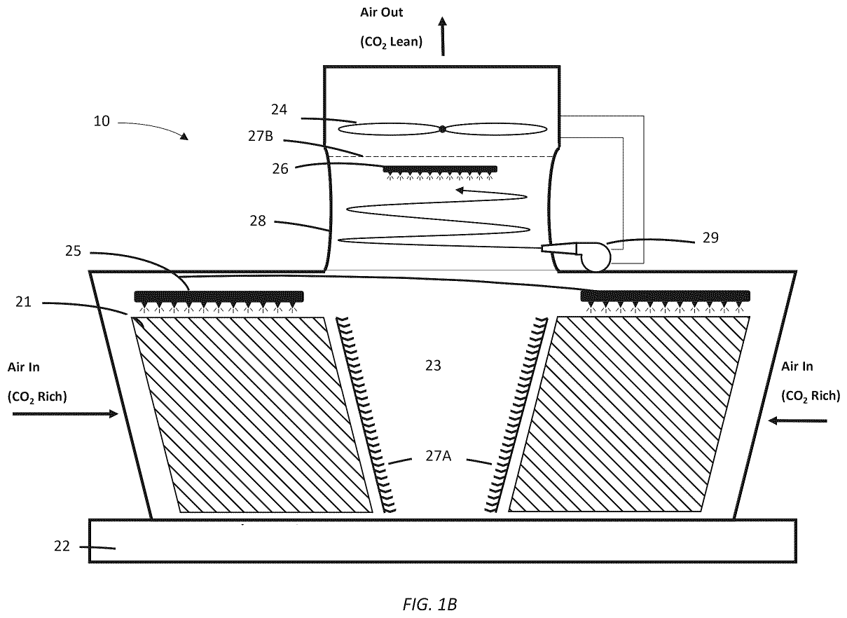

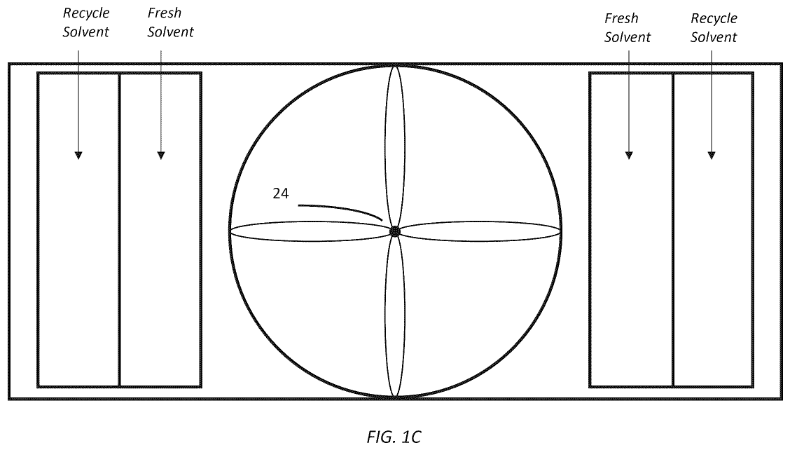

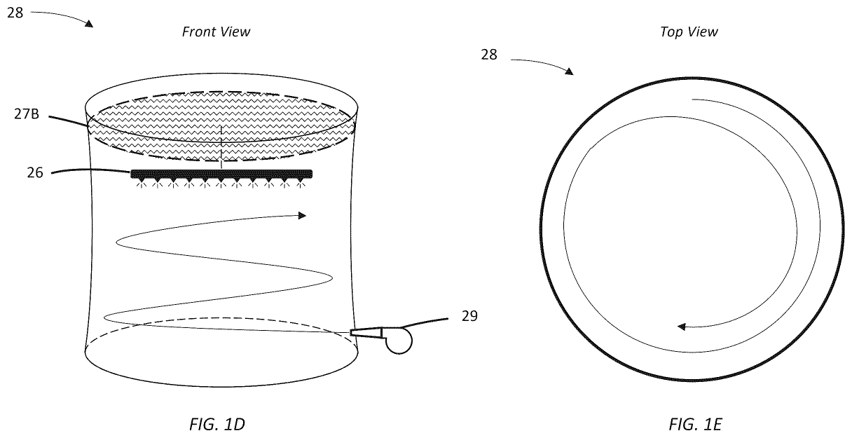

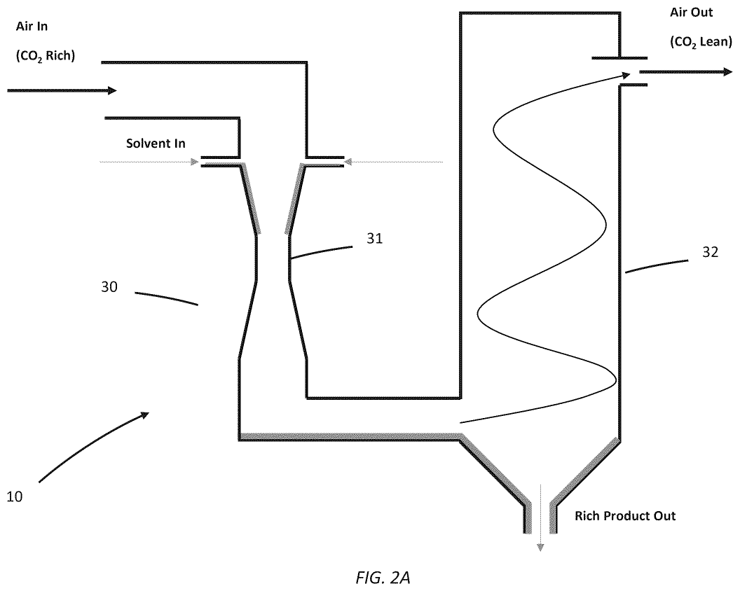

FIGS. 1A and 1B depict two possible configurations of an ambient air reactor (AAR) 10 according to various implementations. Both configurations accomplish the same task of using a liquid sorbent for capturing CO₂ from ambient air. FIG. 1A depicts a counter-current flow AAR wherein the liquid solvent moves vertically, from top to bottom over packing material and contacts with air moving vertically but from bottom to top. FIG. 1B depicts a cross-current flow AAR wherein the liquid solvent moving vertically from top to bottom, contacts with air moving horizontally.

In various implementations, the CO₂ from ambient air (e.g., typically at 300-400 ppm level) is absorbed in the liquid solvent to form carbonates. The outgoing air leaving the AAR is, therefore, lean in CO₂ concentration. In various cases, depending on the relative humidity of the air coming in, some of the water from the liquid solvent solution is evaporated, thus increasing the relative humidity of the outflow air stream relative to the incoming air stream.

According to various examples, in the configurations of both FIGS. 1A and 1B, liquid solvent is pumped up to the top of the AARs 10 and evenly distributed across the area of the contactor packing 21. In some cases, the packing is made of PVC material to prevent corrosion. The absorption of CO₂ into liquid solvent producing carbonates in an aqueous solution rather than in solid form helps to mitigate fouling and sedimentation inside the equipment and piping. The absorption process can be run in a batch mode, semi-batch mode, or in continuous mode by altering the liquid solvent flow into and out of the AAR. Any suitable liquid solvent can be used depending upon the requirements of a particular implementation. In various implementations the liquid solvent includes a hydroxide, such as sodium hydroxide.

FIG. 1A shows a detailed cross-section of a counter-current flow AAR configuration according to various implementations. In this case a lean solvent enters the AAR at the top and is gravity fed through the packing fill distributors 25 trickling down through the packing fill 21 into a basin 22 of the AAR. As the solvent trickles down, it reacts with CO₂ in the air flow, thus producing a stream of aqueous carbonate solution. In various cases the aqueous carbonate solution (including unreacted liquid solvent) is recycled back to the top of the packing fill 21 for further reaction conversion, optionally with a continuous or periodic infusion of fresh solvent. The concentration of the liquid solvent can vary. Along with the lean and recycled solvent that loops through the AAR (e.g., along with aqueous carbonate), ambient air from the surrounding environment is pulled into the AAR from the bottom inlet 20 and flows through packing 21. In some cases, the air continues through a packing drift eliminator 27A to remove any liquid entrainment and enters the vortex scrubbing section 28, and continues through a vortex scrubber drift eliminator 27B to the fan 24 where it exits at the top.

The vortex scrubbing section 28 creates a cyclic vortex motion that spirals upwards through the AAR. In the depicted example, the blower 29 intakes from the airspace above the tower fan 24 exhaust and shoots a pressurized stream of air along the perimeter of the vortex section. The blower 29 may optionally blow fresh ambient air along with or instead of the recycled exhaust air in various cases. In various configurations, the vortex scrubber's outer shell can be a hyperboloid as depicted in FIG. 1A or a cylinder. The vortex scrubber liquid distributor 26 (e.g., one or more spray nozzles) in various implementations is fed from the recycled carbonate/solvent solution pumped from the tower basin 22, optionally with a continuous or periodic infusion of fresh solvent. The size and shape of the vortex scrubbing section can be altered relative to the entire AAR to optimize the amount of CO₂ absorbed from ambient air.

FIG. 1B shows details of a crossflow AAR according to various implementations. The lean solvent with variable concentration feeds into the top of the AAR through the packing fill distributors or nozzles 25 and trickles down through the packing fill 21 into the basin 22 of the tower where it is recycled back to the top of the tower for further reaction conversion. As the lean and recycled solvent loops through the contactor, air from the surrounding environment is pulled into the contactor from the left and right sides of the contactor as shown in FIG. 1B and follows a contorted flow path through the tower packing 21 and in some cases the packing drift eliminator 27A to the center of the AAR known as the plenum 23.

At the plenum 23, the air flow is pulled upward to the vortex scrubbing section 28 where it begins to take on a turbulent flow, such as a spiraling flow path influenced by the blower 29. In various cases, the blower 29 is flush against the wall of the vortex scrubber to aid in perpetuating a vortex motion of the air as it travels upwards through the tower. From here the air flow will continue upwards past the vortex scrubber distribution nozzles 26 and through an optional final vortex scrubber drift eliminator 27B to remove any remnants of liquid entrainment. In various implementations a vertically mounted axial fan 24 forces the air back into the atmosphere as a CO₂ lean exhaust stream. In various configurations, the vortex scrubber's outer shell can be a hyperboloid as depicted in FIG. 1B or a cylinder.

FIGS. 1A and 1B also depict the packing distribution system of nozzles 25 that allows for even dispersal of the solvent over the packing fill. In various implementations, this system is similar to that of typical gravity-fed distributors in cooling tower applications. In various implementations, the vortex scrubber liquid distributor 26 receives recycled solvent from the basin 22 and sprays the liquid into the vortex chamber to contact with the exiting liquid and further drive the reaction conversion. According to various implementations, the packing and scrubber distributors 25, 26 can include any suitable number of nozzles (e.g., one or more) for distributing the liquid solvent.

In various implementations, the packing drift eliminator 27A can be removed to aid in energy savings for the axial fan. The packing drift eliminator acts to desaturate the air flow entering the vortex scrubbing section for potential improvements in mass transfer and reaction conversion.

In various cases the packing fill 21 for the AAR will extend longer across the basin for the application of carbon capture to increase the residence time of the airflow. Typical packing fill depths in crossflow cooling towers are of 1-2 m lengths but can be doubled or even quadrupled in the AAR.

FIG. 1C shows the containment or liquid holdup of the fresh and recycled solvent in the AAR 10 as rectangular trays with vertical depth sitting above the tower packing. In various cases a concentration gradient is present across the right-to-left length of the distribution pan so that the fresh solvent (with a higher concentration) is applied near the center of the contactor and nearer to the air flow's exit from the packing fill 21, while the recycled solvent (with a lower concentration) is applied near the outside of the contactor where the ambient air is received at an entrance to the packing fill. The concentration gradient across the solvent promotes better extraction of CO₂ from the air near the center of the AAR where the concentration of CO₂ is lower and more difficult to extract. The concentration gradient can be altered in its position and intensity to optimize the extraction of CO₂ from the ambient air.

Alternate perspectives of the vortex scrubbing section 28 are given in FIGS. 1D and 1E. In various implementations, the geometry of the outer shell of the scrubbing section is a hyperboloid. This shape is currently utilized in cooling tower fan casings and can be employed in the vortex scrubbing section 28 for similar aerodynamic benefits. The vortex flow can provide better mixing characteristics and/or entrainment reduction for the exiting gas flow, hence improving the capture efficiency and reducing the water loss of the AAR 10.

The front view of FIG. 1D shows a transparent visual of the vortex scrubbing section 28 where the airflow exiting the packing fill 21 enters. The blower 29 acts to introduce a spiraling motion into the upward-moving air as it mixes with the liquid solvent sprayed from the vortex scrubber liquid distributor 26. The vortex scrubber's drift eliminator 27B acts as a final layer of protection to prevent any liquid entrainment of the caustic in the CO₂ lean air returning to the atmosphere. The top view of FIG. 1E is a cross-section of the vortex scrubber 28 that aids in visualizing the radial extension of the swirling airflow created by the blower.

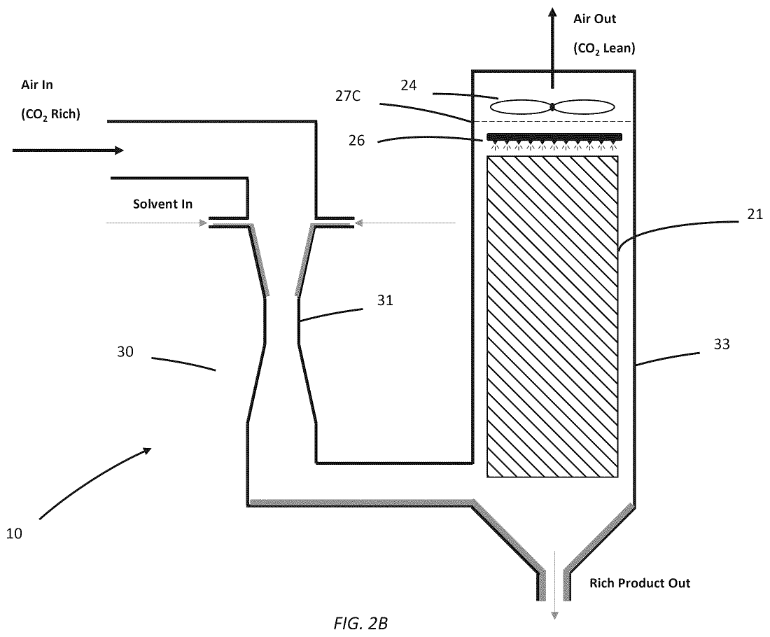

FIG. 2A gives a cross-section view of an alternate configuration of the AAR 10 where the liquid solvent is atomized in a venturi 31 to increase the surface area available for gas-liquid mass transfer according to various implementations. Compressed air enters at the top left side of an atomization stage 30 where it contacts pressurized solvent fed to the throat of the venturi. The atomization stage 30 may also be referred to herein as an atomization chamber and/or component. Once the contact is performed, the stream of aqueous carbonate solution continues its descent and collects at the bottom of the venturi component where it is carried into the adjacent separation component 32 of the AAR. The separation compartment is used to reduce the entrainment of the liquid solvent in the exiting CO₂ lean exhaust air. The drain at the bottom of the separation component transports the liquid carbonate away from the AAR. The pressurized air that exits from the venturi also enters the separation component but is pushed upwards to the air outlet in a turbulent and/or spiral motion, similar to a cyclone separator.

According to various implementations, the AAR configuration of FIG. 2A AARs can be used alone or in tandem with the configuration(s) of FIGS. 1A and/or 1B. In various cases the FIG. 2A configuration can be placed either before or after the 1A and/or 1B configuration(s).

FIG. 2B is similar in configuration to FIG. 2A, however, is modified so that the separation component is instead replaced with a packed component 33. The packed component processes the liquid and gas flow in a countercurrent flow configuration where the pressurized air from the venturi enters the bottom of the packing and travels upwards through packing 21 and packing component drift eliminator 27C until it contacts the fan 24 and exits through the top of the packing component section. The stream of aqueous carbonate entering the packing component also drains at the bottom of the vessel while fresh and/or recycled solvent is fed to the distribution nozzles 26 above the packing and trickles down through the packing to drain with the liquid entering from the venturi component.

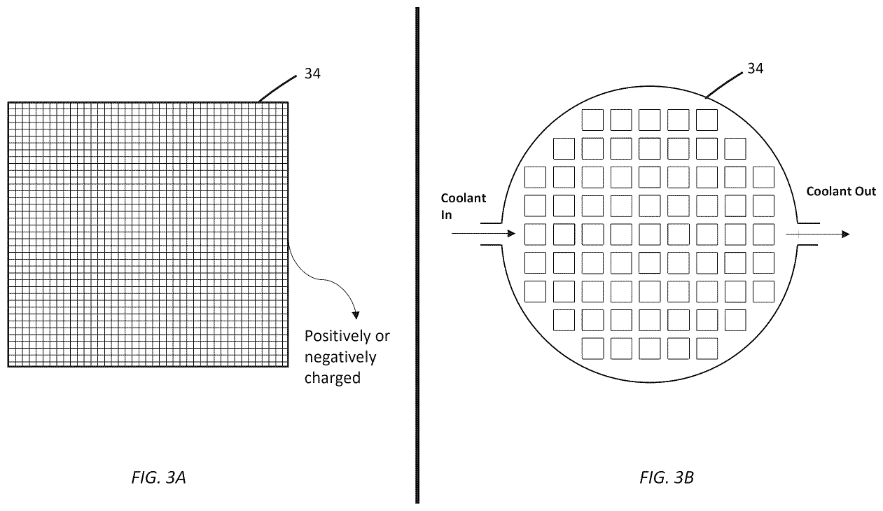

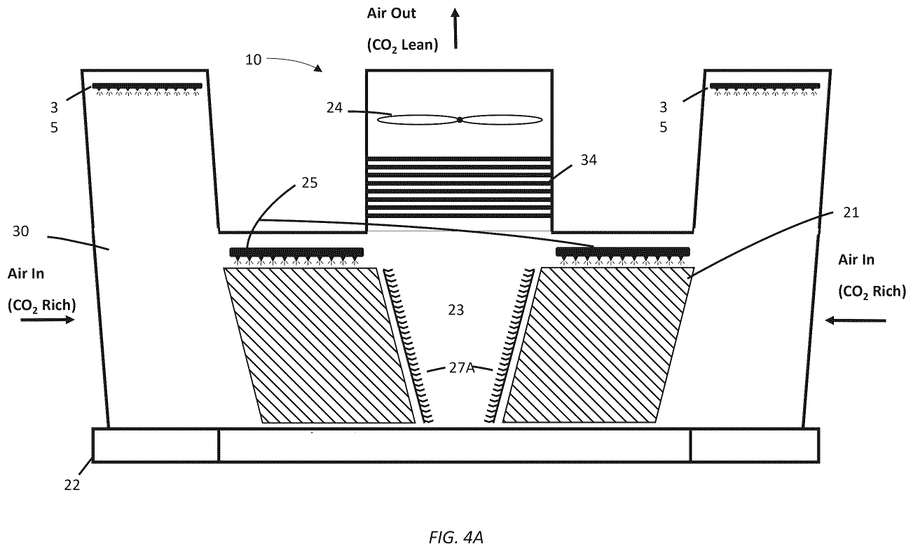

Various implementations of the disclosed technology employ a water vapor filter to reduce the loss of water in the AAR exhaust. FIG. 3A shows an example of a water vapor filter 34 that includes a wire mesh that can be connected to an electrical circuit to produce an opposing charge filter screen for the CO₂ lean exhaust air saturated with water vapor. The exiting air can be charged with the use of electrodes or lasers so that when it contacts the mesh, the water vapor adheres to the mesh and condenses to help reduce the water content in the saturated CO₂ lean exhaust air. FIG. 3B employs a similar concept to FIG. 3A except that the water vapor filter 34 has a mesh composed of hollow tubing that can carry a constantly moving coolant. In various cases water is removed from the exhaust by using a coolant to reduce the temperature of the mesh so that any exiting water vapor that comes into contact with the mesh is condensed and drained with the bottom liquid. In various cases the hollow mesh can also hold an opposing charge to further improve the water vapor removal of the exhaust.

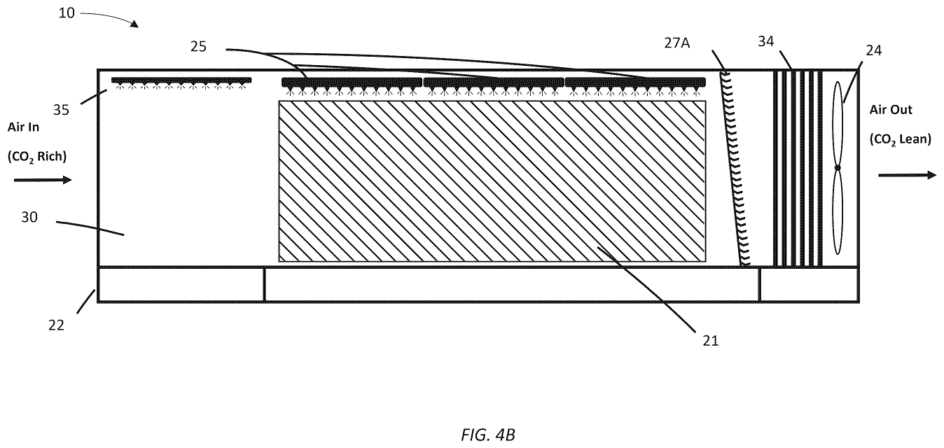

The examples of FIGS. 4A and 4B build on the examples of FIGS. 3A and 3B to show methods of water conservation that can be implemented both before and after the main solvent and ambient air contact takes place in the packing section 21. Initially, ambient air that enters the AAR is contacted against an atomized solvent sprayed from one or more atomizing spray nozzles 35. The atomized solvent reacts with the CO₂ in the air and reduces the air temperature through evaporative cooling. The atomized solvent spray is recycled from the sectioned collection basin and is cooler and richer in CO₂ than the fresh solvent to both provide a concentration gradient along the absorption path of the air flow and to help cool the air for water loss conservation. FIGS. 4A and 4B also depict the location of the cooling plate or electrically charged wire mesh apparatus 34 downstream of the packing section 21. The cooling plate and mesh are interchangeable depending on the environmental factors of the AAR location. The cooling plate is connected to a chiller refrigeration unit to maintain the temperature of the cooling plate below the dew point of the exhaust air. The cooling plate is stacked vertically in parallel to the coolant flow and in series to the perpendicular exiting air flow to improve the condensed water recovery. The charged mesh similarly will have some additional auxiliary components and equipment to perform the condensation of the exhaust air stream. Artificial intelligence modules can be implemented into the PLC that controls the flow of both the recycled solvent spray and cooling plate coolant to optimize for water loss conservation.

Although the disclosure has been described with reference to certain implementations and embodiments, persons skilled in the art will recognize that changes may be made in form and detail without departing from the spirit and scope of the disclosed apparatus, systems and methods.

1. A method for capturing carbon dioxide (CO₂) from ambient air, comprising:
receiving an air flow comprising ambient air;
passing the air flow through a packing fill in a laminar manner, the air flow comprising a laminar air flow within the packing fill;
introducing a liquid solvent into the packing fill;
producing a first stream of aqueous carbonate solution through a reaction between the liquid solvent and CO₂ in the laminar air flow;
introducing the liquid solvent into a scrubbing chamber;
passing the air flow through the scrubbing chamber in a turbulent manner, the air flow comprising a turbulent air flow within the scrubbing chamber;
mixing the turbulent air flow with the liquid solvent in the scrubbing chamber to produce a second stream of aqueous carbonate solution through a reaction between the liquid solvent and CO₂ in the turbulent air flow; and
exhausting the air flow with less CO₂ than when receiving the air flow.

2. The method of claim 1, further comprising adding turbulence to the air flow within the scrubbing chamber by blowing additional air into the scrubbing chamber at an acute angle relative to a direction of the air flow entering the scrubbing chamber and with a speed greater than a speed of the air flow entering the scrubbing chamber.

3. The method of claim 1, wherein the additional air comprises a recycled portion of the exhausted air flow.

4. The method of claim 1, wherein introducing the liquid solvent into the packing fill and into the scrubbing chamber comprises introducing a recycled portion of the first stream and/or the second stream.

5. The method of claim 1, wherein introducing the liquid solvent into the packing fill comprises introducing the liquid solvent with a concentration gradient along the direction of the air flow through the packing fill.

6. The method of claim 5, wherein introducing the liquid solvent with a concentration gradient comprises introducing two or more concentrations of the liquid solvent into corresponding separate regions of the packing fill.

7. The method of claim 6, wherein the packing fill comprises an air flow entrance and an air flow exit, wherein the two or more concentrations comprise a first concentration and a second concentration and the corresponding separate regions comprise a first region and a second region, wherein the first region is closer to the air flow entrance than the second region and the second region is closer to the air flow exit than the first region, and wherein the second concentration is greater than the first concentration.

8. The method of claim 1, further comprising atomizing the liquid solvent, passing the air flow through the atomized liquid solvent, and producing a third stream of aqueous carbonate solution through a reaction between the atomized liquid solvent and CO₂ in the air flow.

9. The method of claim 8, further comprising passing the air flow through a venturi while introducing the liquid solvent into the venturi to atomize the liquid solvent.

10. The method of claim 8, wherein atomizing the liquid solvent comprises spraying the liquid solvent with at least one atomizing spray nozzle.

11. The method of claim 8, further comprising passing the air flow through a separation chamber configured to reduce entrainment of the liquid solvent in the air flow.

12. The method of claim 11, wherein the separation chamber comprises additional packing fill and further comprising introducing the liquid solvent into the additional packing fill and passing the air flow through the additional packing fill.

13. The method of claim 1, further comprising passing the air flow through a water vapor filter, thereby removing water vapor from the air flow.

14. The method of claim 13, wherein the water vapor filter comprises a mesh, and further comprising electrically charging the mesh to attract and condense water vapor molecules upon the mesh.

15. The method of claim 13, wherein the water vapor filter comprises tubing, and further comprising flowing a coolant through the tubing to cool the air flow and condense water vapor molecules upon the tubing.

16.-21. (canceled)
